(19) United States
(12) Patent Application Publication
(10) Pub. No.: US 2012/0031277 A1
(43) Pub. Date: Feb. 9, 2012

(54) DRINK CAN

(76) Inventors: CHUN-SHU HSIEH, Kaohsiung City (TW); PEI-SHAN HSIEH, Kaohsiung City (TW)

(21) Appl. No.: 12/852,489

(22) Filed: Aug. 8, 2010

(51) Int. Cl. A47J 31/00; B65D 41/04

(52) U.S. Cl. 99/289 R; 220/288

(57) ABSTRACT

A drink can includes a can body with a resilient portion, a cap located on a bottle mouth of the can body and a separated holding portion coupled with the cap. The resilient portion is coupled with one set of pressure guards. The separated holding portion connected to the cap holds concentrate of a brewing stuff with a taste different from that held in the can body. The resilient portion formed on the belly of the can body can be squeezed to make a conical portion at the bottom of the can body to dislocate and open a sealing plate at the distal end of the separated holding portion, so that the concentrate of the brewing stuff can quickly drop into the can body to be diluted by the brewing liquid held in the can body to quickly mix the brewing liquid and brewing stuff.

### FIELD OF THE INVENTION

The present invention relates to a drink can and particularly to a drink can that has a resilient portion on the belly of the can that is squeezable to make a conical portion to dislocate a sealing plate at a distal end of a separated holding portion to quickly mix brewing liquid and brewing stuff.

### BACKGROUND OF THE INVENTION

A conventional drink can generally contains liquid which can be drunk directly. To prevent staling of the liquid during the preservation period, a preservative usually is added in the liquid to prolong the preservation period. However, increasing health-care awareness in recent years demands less use of the preservative. To extend the preservation period of the drink, an improved drink can 1 as shown in FIG. 1 has been developed. It mainly includes a storage compartment 121 in a cap 10 to hold concentrate of a brewing stuff 122 for a longer period without spoiling. The cap 10 is mounted onto a container 20 which generally holds drinking water or alcohol drink. When in use, the brewing stuff 122 is mixed with the drinking water or alcohol drink. The cap 10 shown in FIG. 1 includes an outer cup 11 and an inner sleeve 12. The outer cup 11 has an outer ring 112 and an inner ring 113 and an interval space 114 formed between them. The inner sleeve 12 is coupled on the outer circumference of the inner ring 113. The storage compartment 121 is formed between the inner ring 113 and inner sleeve 12 to hold the concentrate of the brewing stuff 122. The inner sleeve 12 has a threaded rim 123 butting one end surface of a bottle mouth 21, a cut slot 124 formed at one side remote from the threaded rim 123, and a sealing plate 125 at the bottom. When in use, the outer cup 11 is moved towards the container 20 to open the storage compartment 121 so that the brewing stuff 122 can automatically drop into the container 20. The cap 10 thus formed still has drawbacks in practice, notably:

1. Since the brewing stuff 122 is held in the cap 10, the height of the cap 10 has to be increased that makes the total product higher and package more difficult. When displaying the product is desired on the shelves, it is difficult or impossible to place the product vertically. As a result, it is less likely to attract customer's attention.

2. The bottle mouth 21 has external threads 211 to screw with internal threads 1121 formed on the outer ring 112, and a great number of screwing has to be done to turn the outer cup 11 to a desired location on the external threads 211 to open the storage compartment 121 and drop the brewing stuff 122 into the container 20. Turning the cap 10 is time-consuming and troublesome.

### SUMMARY OF THE INVENTION

Therefore, the present invention aims to provide a drink can to solve the problems of the conventional drink can that have a greater height and require longer screwing time of the cap. The drink can according to the invention has a resilient portion on the belly of the can that is squeezable to make a conical portion to dislocate a sealing plate at a distal end of a separated holding portion to quickly mix brewing stuff and brewing liquid.

The drink can of the invention includes a can body with a resilient portion formed thereon, a cap mounted on a bottle mouth of the can body and a separated holding portion coupled with the cap. The resilient portion is coupled with a set of pressure guards. The can is covered by a packaging film. The separated holding portion coupled with the cap holds concentrate of a brewing stuff with a taste different from a drink contained in the can body. The resilient portion formed on the belly can be squeezed to make a conical portion at the bottom of the can body to dislocate a sealing plate at the distal end of the separated holding portion, so that the concentrate of the brewing stuff held in the separated holding portion can quickly drop into the can body to be diluted by the brewing liquid, and then the brewing stuff can be mixed with the brewing liquid.

The structure of the invention set forth above provides many benefits, notably:

1. As the interior housing space of the separated holding portion can hold the concentrate of the brewing stuff, the height of the can body will not be increased, product profile is unchanged, package is easier, and the drink cans can be vertically displayed on the shelves to attract customer's attention.

2. The resilient portion on the belly of the can is squeezable to make the conical portion to dislocate the sealing plate at the distal end of the separated holding portion, hence the brewing stuff can be quickly mixed with the brewing liquid.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a sectional view of a conventional drink can assembled with a container.

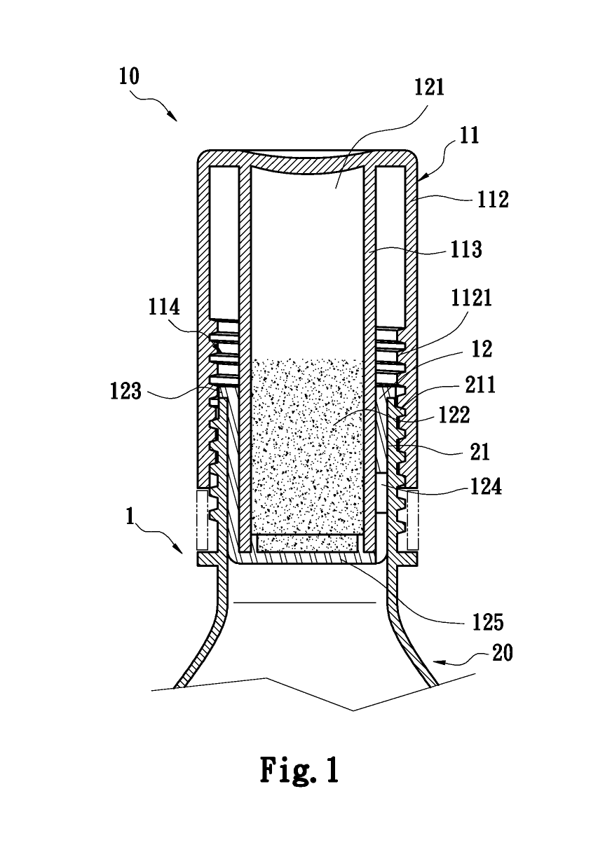

FIG. 2 is a perspective view of the drink can of the invention covered by a packaging film.

FIG. 3 is an exploded view of the drink can and one set of pressure guards according to the invention.

FIG. 4 is an exploded view of the drink can of the invention.

FIG. 5A is a sectional view of the drink can of the invention.

FIG. 5B is a cross section taken on line 5B-5B in FIG. 5A.

FIG. 6 is a schematic view showing the resilient portion in a squeezed condition according to the invention.

FIG. 7 is a schematic view showing the sealing plate of the separated holding portion squeezed by the conical portion according to the invention.

FIG. 8 is a sectional view showing the connector of the sealing plate dislocated by the conical portion according to the invention.

FIG. 9 is an enlarged sectional view according to FIG. 8.

FIG. 10 is a schematic view showing the resilient portion returning to its original condition according to the invention.

### DETAILED DESCRIPTION OF THE PREFERRED EMBODIMENT

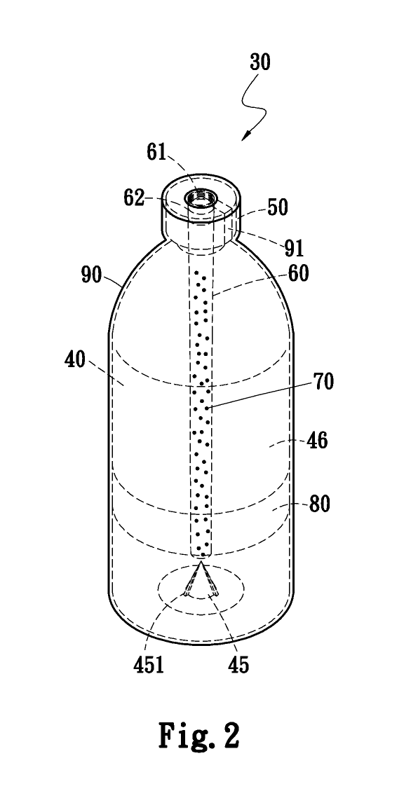

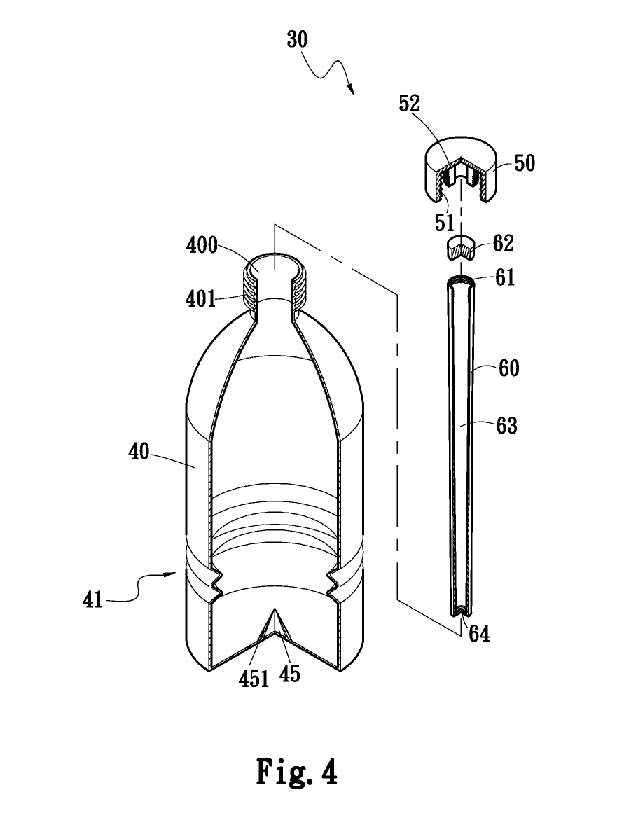

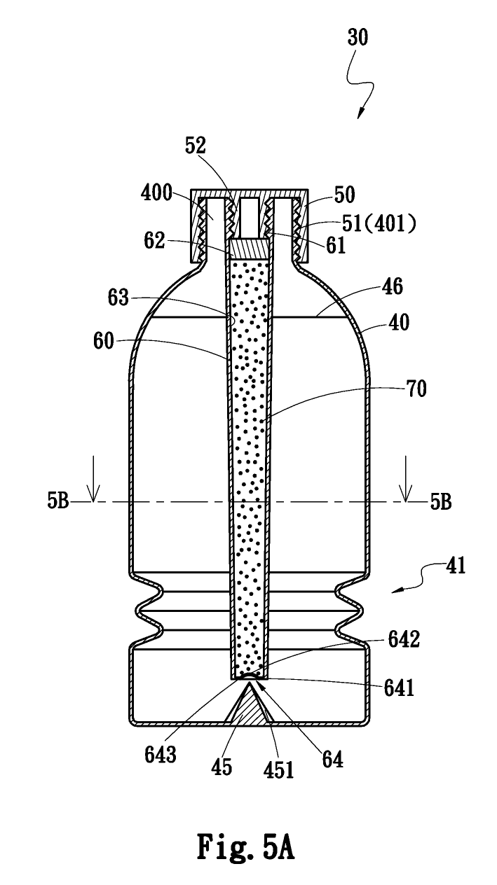

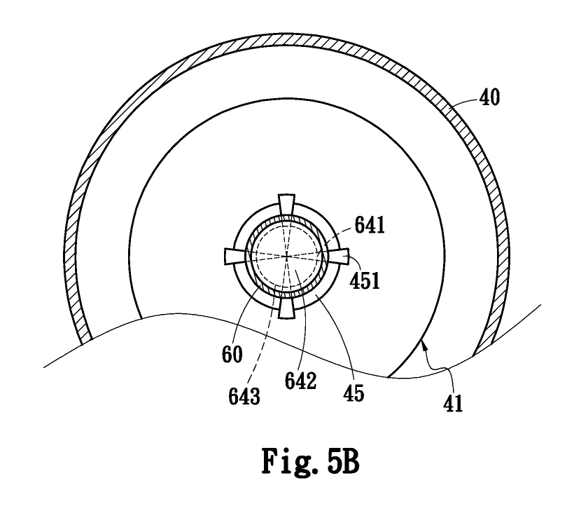

Please refer to FIGS. 2 through 5B for an embodiment of a drink can 30 of the invention. It aims to quickly drop concentrate of a brewing stuff 70 held in a separated holding portion 60 into a can body 40.

The can body 40 has an elastic and section-folding resilient portion 41 on the belly and a conical portion 45 formed on the inner side of the bottom. The conical portion 45 has a plurality of reinforced ribs 451 on the outer circumference. The can body 40 has a bottle mouth 400 with an external thread portion 401 formed thereon. The can body 40 contains a brewing liquid 46.

The drink can 30 also includes a cap 50 with an internal thread portion 51 formed on the inner circumference to be screwed with the external thread portion 401 of the bottle mouth 400, and a screw bar 52 in the center with external threads formed thereon.

The separated holding portion 60 is a conical rod gradually shrunk from top to bottom and has internal threads 61 at one end screwed with the screw bar 52 of the cap 50 and a pliable member 62 located beneath the internal threads 61 formed in a conical shape and contacted tightly with the separated holding portion 60 to prevent the concentrate of the brewing stuff 70 held in the housing space 63 of the separated holding portion 60 from seeping outside. The separated holding portion 60 has a sealing plate 64 at a lower end surface which has a concave arched member 642 to guide the conical portion 45. The concave arched member 642 has a thin connecting ring 643 on the outer circumference that is easily broken off by pushing of the conical portion 45 and a connector 641 connected to the sealing plate 64.

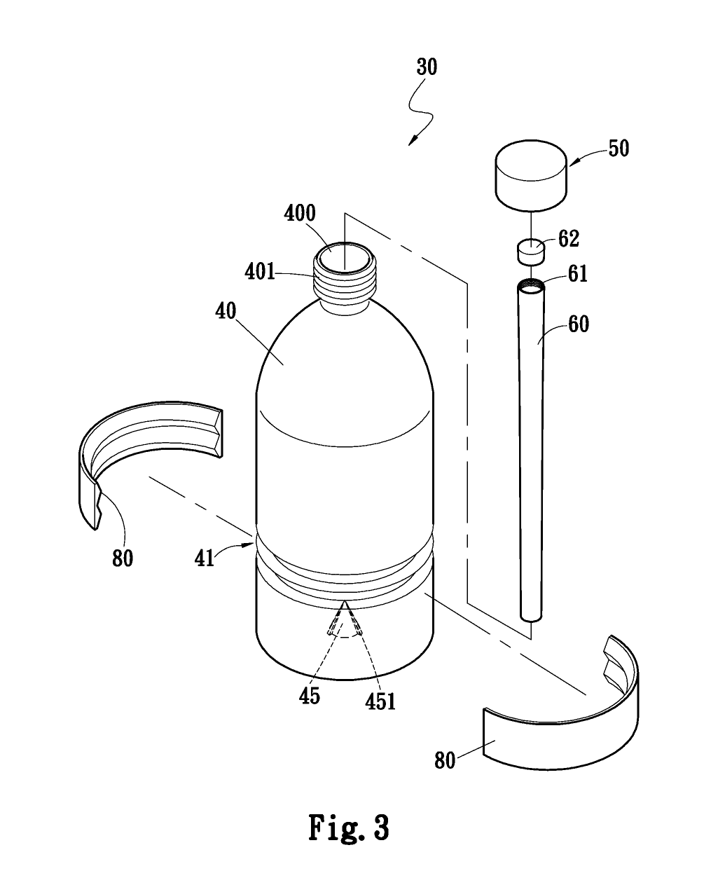

The invention further includes a set of pressure guards 80 coupled on the resilient portion 41 (referring to FIG. 3). The set of pressure guards 80 is formed in a semicircular shape with a flat surface on one side and a section-folding surface on another side mating the resilient portion 41.

The invention also includes a packaging film 90 to cover the drink can 30, pressure guards 80 and cap 50. It has a tearing line 91 to allow users tearing off and then taking out the pressure guards 80. Then the resilient portion 41 can be squeezed to allow the conical portion 45 pushing and opening the sealing plate 64 of the separated holding portion 60, so that the concentrate of the brewing stuff 70 can quickly drop into the can body 40 to be diluted by a brewing liquid 46 contained in the can body 40 to quickly mix the brewing liquid 46 and brewing stuff 70.

For assembly of the invention, referring to FIGS. 2 through 5B, first, fill the brewing stuff 70 in the housing space 63 of the separated holding portion 60; place the pliable member 62 below the internal threads 61 of the separated holding portion 60 in a butting manner; move the cap 50 towards the bottle mouth 400 of the can body 40 and screw the internal thread portion 51 of the cap 50 with the external thread portion 401 of the bottle mouth 400 so that the screw bar 54 extended from the center of the cap 50 gradually presses the pliable member 62 and the conical pliable member 62 forms a tight compact condition in the conical housing space 63 to prevent the brewing stuff 70 held therein from spilling out; couple one set of the pressure guards 80 on the section-folding resilient portion 41 (referring to FIG. 3); and package the drink can 30 by covering the packaging film 90 which has the tearing line 91 formed thereon (referring to FIG. 2).

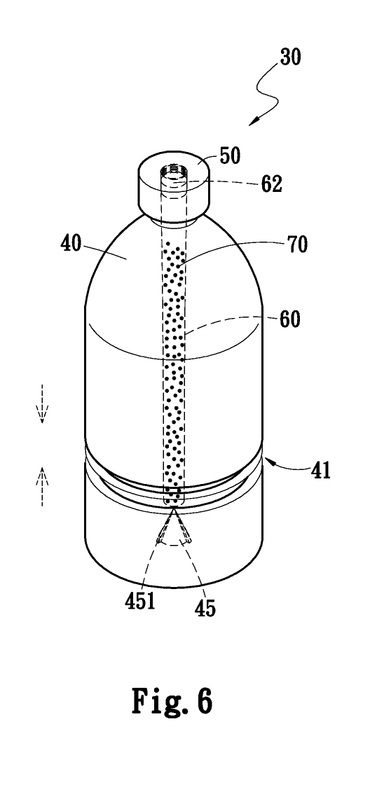

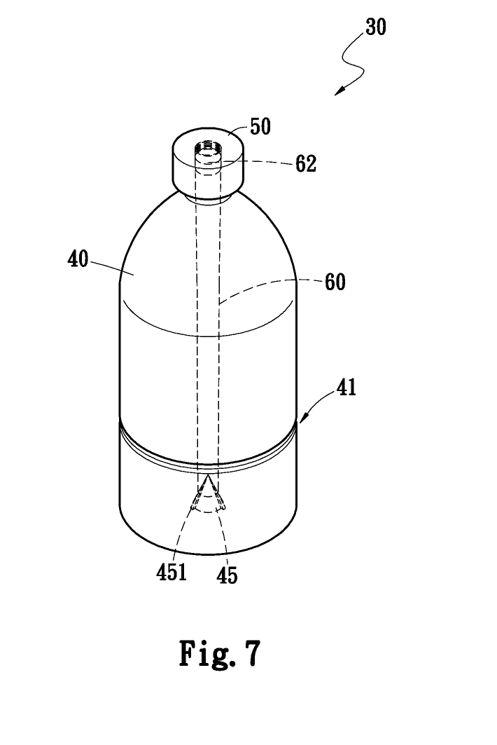

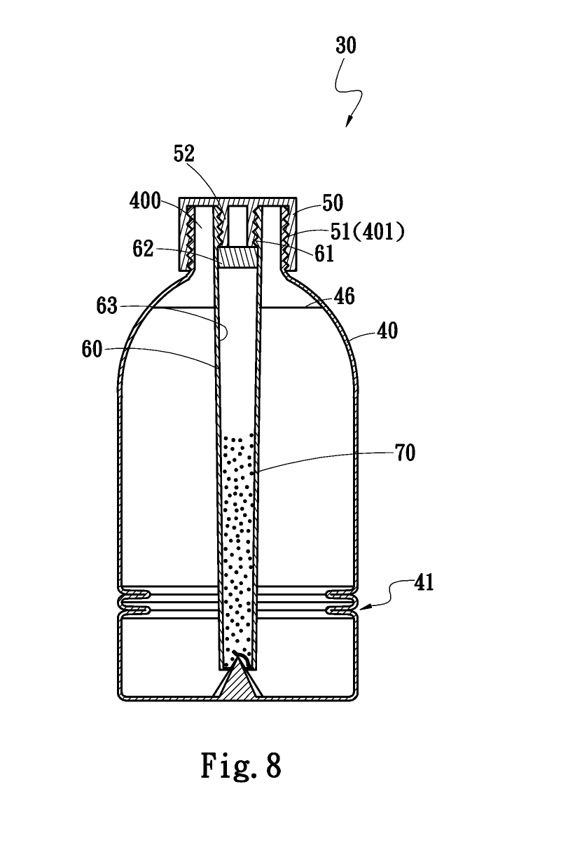

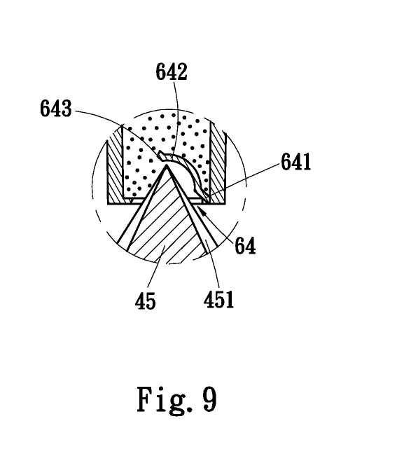

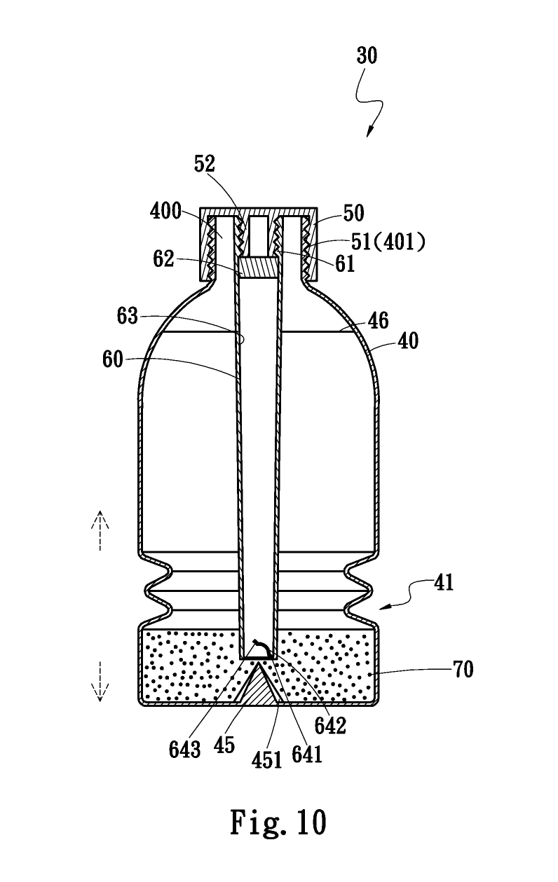

Referring to FIGS. 2 and 3, when the drink can 30 is in use, a user tears out the tearing line 91 on the surface of the packaging film 90 and takes out a set of the pressure guards 80; referring to FIGS. 6 and 7, squeeze the can body 40 to press the resilient portion 41, the conical portion 45 at the bottom of the can body 40 butts the concave arched member 642 and the concave arched member 642 guides the conical portion 45 to be a vertical condition to dislocate the sealing plate 64 at the distal end of the separated holding portion 60; the thin connecting ring 643 is fractured so that the connector 641 is connected to the sealing plate 64, thus the sealing plate 64 is open (referring to FIGS. 8 and 9); if the resilient portion 41 does not receive the pushing force, it will return to the original condition, and the concentrate of the brewing stuff 70 held in the separated holding portion 60 can quickly drop into the can body 40 through the opened sealing plate 64 (referring to FIG. 10) to be diluted by the brewing liquid 46 to quickly mix the brewing liquid 46 and brewing stuff 70.

What is claimed is:

1. A drink can, comprising:
a can body which includes an elastic and section-folding resilient portion on a belly thereof, a bottle mouth at one end formed an external thread portion and a conical portion on an inner side of the bottom thereof;
a cap which includes an internal thread portion on an inner circumference screwed with the external thread portion of the bottle mouth and a screw bar located inside including external threads; and
a separated holding portion which includes internal threads coupled with the screw bar, a pliable member at an inner upper side pressed by the screw bar to form compact coupling and a sealing plate at a lower end surface thereof corresponding to the conical portion of the can body.

2. The drink can of claim 1 further including one set of pressure guards coupled on the resilient portion, each pressure guard being formed in a semicircular shape and including a flat surface on one side and a section-folding surface on another side corresponding to the resilient portion, and a packaging film to cover the drink can, the pressure guards and the cap.

3. The drink can of claim 2, wherein the separated holding portion includes a conical housing space to hold a brewing stuff, the separated holding portion is a conical rod gradually shrunk from the top to the bottom thereof and includes a connector connected to the sealing plate and a concave arched member formed with a thin connecting ring, the can body being filled with a brewing liquid.
